(19) United States
(12) Patent Application Publication
(10) Pub. No.: US 2016/0364959 A1
(43) Pub. Date: Dec. 15, 2016

(54) ELECTRONIC RECEIPT SYSTEM

(71) Applicant: TELSTRA CORPORATION LIMITED, Melbourne, Victoria (AU)

(72) Inventors: David GIDDY, Glen Iris, Victoria (AU); Andrew Ewart SCOTT, Melbourne, Victoria (AU)

(21) Appl. No.: 15/121,397

(22) PCT Filed: Feb. 25, 2015
(86) PCT No.: PCT/AU2015/050075

§ 371 Date: Aug. 25, 2016

(30) Foreign Application Priority Data
Feb. 25, 2014 (AU) 2014900605

(51) Int. Cl. G07G 5/00; G06Q 20/38

(52) U.S. Cl. CPC G07G 5/00; G06Q 20/385

(57) ABSTRACT

An electronic receipt computer system includes a merchant system storing receipt data representing respective receipts for products; a payment system of a payment account provider storing transaction data representing respective payment transactions and indicating the associated customer; and a receipt database system. The receipt data is anonymous. The receipt database system includes: a vault database storing the receipt data received from the merchant system; a parser generating respective receipt signatures from the receipt data; and a matching engine for matching the transaction data from the payment system with the receipt signatures. The vault database (120) stores the transaction data for a receipt matched by the matching engine in association with the receipt data for the matched receipt and customer identification data for the customer. Associated transaction data and receipt data is accessed from the vault database and presented for a client device when requested by the customer using the client device.

### FIELD

The present invention relates to an electronic receipt system.

### BACKGROUND

Retailers issue receipts itemising the products (goods or services) purchased by a customer. Receipts are typically printed when a purchase transaction has been completed, and it is up to the customer to retain receipts for a variety of purposes, such as for evidence for warranty periods or taxation records. Diligent retention and recording of receipts is problematic for most customers. A number of retailers are able to provide electronic receipts to customers, when they are in the possession of customer data, such as an email address, that allows the electronic receipt to be delivered to the customer. Yet it is still up to the customer to retain and store these individual retailer receipts.

In some cases, the receipt for the purchased product(s) is provided or represented by the invoice or bill issued by a retailer or merchant. The receipt provided by the invoice may be paid immediately or at some date in the future that may be specified on the invoice. Once paid, the customer then usually receives payment confirmation information which may be a simple reference number. In some cases, no confirmation reference is generated.

Another significant difficulty is associated with reconciling transactions on a payment account, such as a credit or debit account, with purchases that have been made. This tends to be exacerbated because the transaction records in the payment accounts only provide the total amount of the transaction, and this can be allocated to a retailer or merchant name that bears no resemblance to the trading name of the retailer from which the products have been purchased.

Whilst the computer systems used by merchants and payment account providers, such as banks and other financial institutions, are considerably technically complex and sophisticated, none of the existing systems address all of the above difficulties. Accordingly, it is desired to provide a system that addresses the above or at least provides a useful alternative.

### SUMMARY

An embodiment of the present invention provides an electronic receipt system, including a receipt database system and configured to:
receive and store anonymous receipt data from a least one merchant system, the receipt data representing respective receipts for products purchased;
receive transaction data, representing respective payment transactions and indicating the customer associated with each transaction;
process the transaction data and receipt data to attempt to match the receipts to the transactions; and
store the transaction data for a matched receipt in association with the receipt data for the matched receipt and customer identification data for the customer of the transaction.

The transaction data may be processed to generate a transaction signature for each transaction to match with the receipt data. The transaction signature includes at least one of merchant identification, date or time of transaction, transaction amount, account or card digits, and terminal ID data. A receipt signature may also be generated from the receipt data for each receipt for matching with the transaction data or the transaction signature. The receipt signature includes at least one of merchant identification, date and type of payment transaction, transaction amount, account or card digits, and payment terminal identification data.

The customer identification data may include at least one of an account or card number, a username, a mobile phone number, and a generated number unique to the customer.

The electronic receipt system allows accessing and presenting of associated transaction data and receipt data for a client device when requested by the customer using the client device. The electronic receipt system also allows accessing and transmitting associated transaction data and receipt data for processing by an expense management system, a personal financial management system, an accounting system, and a data mining system.

The electronic receipt system is also able to receive and submit an authority from the customer to receive the transaction data, for at least one payment transaction account of the customer, from at least one payment system.

The anonymous receipt data may be received regularly and automatically from at least one merchant system.

An embodiment of the present invention also provides an electronic receipt system, including a receipt database system and configured to:
store receipt data representing respective receipts for products purchased;
receive, from at least one payment system, transaction data, representing respective payment transactions of a payment account of a customer;
process the transaction data and receipt data to attempt to match the receipts to the transactions;
store the transaction data for a matched receipt in association with the receipt data for the matched receipt and customer identification data for the customer of the transaction; and
access and provide associated transaction data and receipt data for a client device when requested by the customer using the client device.

The receipt data may be obtained by parsing a message store associated with a customer, and may also be obtained from at least one merchant system.

An embodiment of the present invention also provides an electronic receipt computer system, including:
at least one merchant system of a merchant storing receipt data representing respective receipts for products purchased from the merchant;
at least one payment system of a payment account provider storing transaction data representing respective payment transactions and indicating the customer associated with each transaction;
a receipt database system including:
   a vault database storing the receipt data of receipts received from the at least one merchant system;
   at least one parser generating respective receipt signatures from the receipt data for the receipts; and
   a matching engine for matching the transaction data from the at least one payment system with the receipt signatures,
   wherein the vault database stores the transaction data for a receipt matched by the matching engine in association with the receipt data for the matched receipt and customer identification data for the customer of the transaction.

The present invention provides a receipt reindentification process including:
processing anonymous receipt data of a receipt of a merchant system to generate a receipt signature; and
processing transaction data, representing respective payment transactions and indicating a customer associated with each transaction, to match transaction data of a payment transaction with the receipt signature and identify the customer with the receipt.

### DRAWINGS

Preferred embodiments of the present invention are hereinafter described, by way of example only, with reference to the accompanying drawings, wherein:

FIG. 1 is a block diagram of a preferred embodiment of an electronic receipt system;

FIG. 2 is a block diagram of at least one computer platform of the receipt system;

FIG. 3 is a flow diagram of a registration process of the receipt system;

FIG. 4 is a flow diagram of a merchant system process;

FIG. 5 is a flow diagram of a payment system process;

FIG. 6 is a flow diagram of a reidentification process of the receipt system; and

FIG. 7 is a screen shot of an interface generated by the electronic receipt system.

### DESCRIPTION

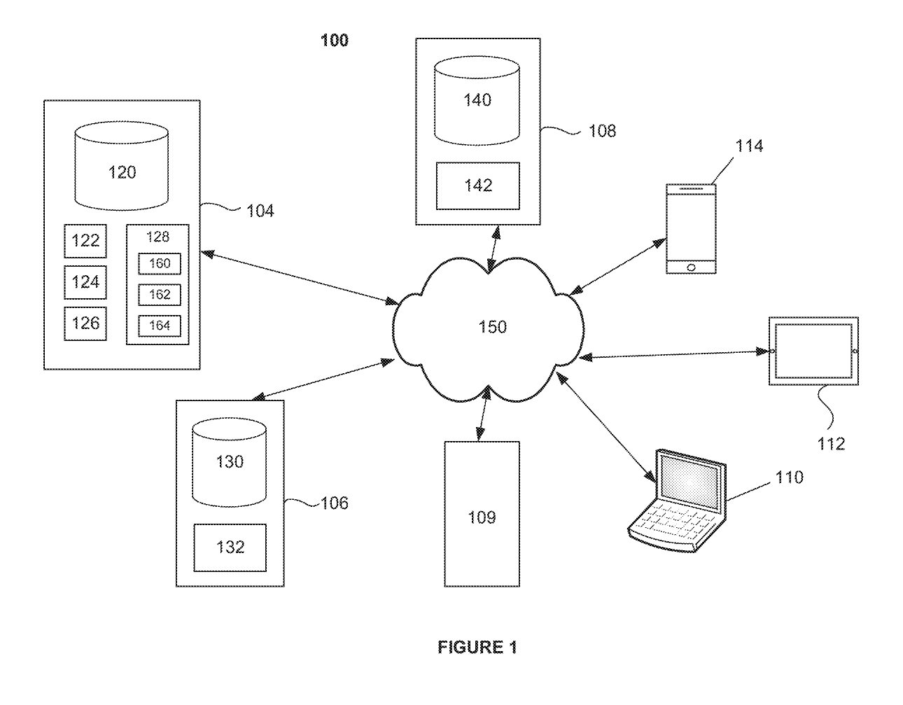

An electronic receipt system 100, as shown in FIG. 1, is based on a computer platform 104 that is configured to store and process receipts for customers in an e-receipt vault database 120. The receipt computer platform 104 communicates with at least one retailer or merchant computer system 106 over a communications network 150 to obtain receipt data representing individual customer receipts, and in particular anonymous receipt data that is not associated with any customer identifier. The receipt data may be unstructured. The receipt platform 104 also communicates with at least one payment computer system 108 over the communications network 150. The payment systems 108 maintain payment transaction accounts used by customers, such as cheque, savings and credit or debit card accounts. For example, the payment systems may be maintained by credit or debit card issuers, e.g. banks, that support the payment schemes, e.g. those provided by Visa Inc. and American Express Inc. The receipt platform 104 obtains transaction data, representing payment transactions from the payment systems 108. This data would normally be structured, such as according to various payment standards, e.g. the EFTPOS standard, depending on the jurisdiction of implementation. The receipt platform 104 is also able to communicate over the communications network 150 with client devices 110, 112, 114 of customers or other parties. The receipt platform 104 is also able to communicate over the communication network 150 with other computer systems 109 that may require access to the vault database 120. For example, the other computer systems 109 may include an expense management system, a personal financial management system, an accounting system, or a data mining system. The customers may be an individual person, or a body corporate or organisation. The receipt platform 104 may also receive receipt data direct from customers, who may forward the receipt data in electronic messages, such as emails, using the customer's client device 110, 112 or 114. Receipt data can also be obtained from mail servers or web servers associated with the customers.

The receipt platform 104 includes a database system 122 such as that provided by Oracle or MySQL, to establish at least one database 120 to provide the e-receipt vault 120. The platform 104 also includes at least an email server 124 and a web server 126 for delivering content and messages over the communications network 150 to client devices 110, 112 or 114. The client devices 110, 112 and 114 comprise computers running client applications to request and access content and messages from the network 150. For example, a client device may be a MacBook Pro laptop 110, an iPad 112 or an iPhone 114, each running Mail and/or Safari client applications, and which are all provided by Apple Inc. A client device 110, 112, 114 may also be part of another computer system or based on other operating systems, e.g. Android, Windows, Linux etc. The platform 104 uses a web services system 128 for providing web services interface to communicate with the merchant systems 106 to obtain the receipt data and the payment systems 108 to obtain the transaction data. Alternatively, other machine to machine or computer to computer (e.g. B2B) interfaces may be used instead of the web services interface, over public or private networks, for example the interfaces may use SFTP, AS2, AS4 etc. The web services system 128 includes at least one parser, scraping engine and matching engine.

The client devices 110, 112, 114 may also be provided with installed dedicated client applications to communicate with the receipt platform 104 to access data held in the vault database 120 and present the data in a predetermined format. For example, the client application may handle authentication of the client device with the platform 104, and may have vault data returned in a specific format, such as JavaScript Object Notation (JSON).

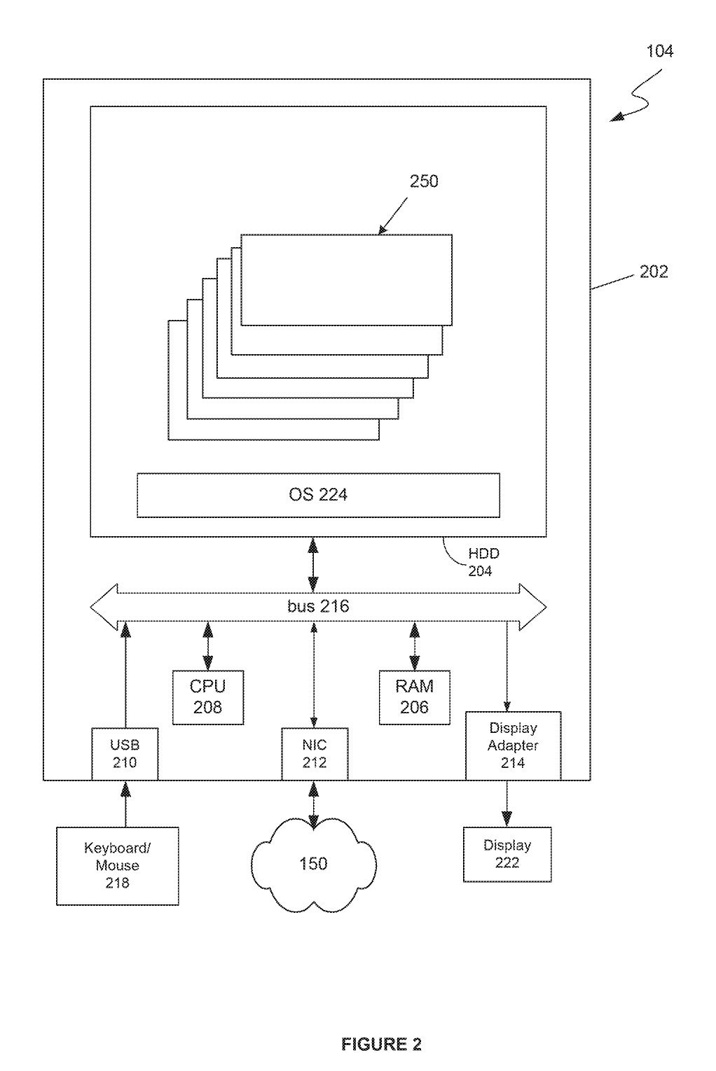

Computer servers of the platforms 104, 106 and 108 may each be based on a standard computer 202, as shown in FIG. 2, such as such as a 32 or 64 bit Intel architecture computer produced by Lenovo Corporation, IBM Corporation, or Apple Inc. The data processes executed by the computer system 202 are defined and controlled by computer program instruction code and data of software components or modules 250 stored on non-volatile (e.g. hard disk) storage 204 of the computer 202. The processes performed by the modules 250 can, alternatively, be performed by firmware stored in read only memory (ROM) or at least in part by dedicated hardware circuits of the computer 202, such as application specific integrated circuits (ASICs) and/or field programmable gate arrays (FPGAs). The processes can also be executed by distributing the modules 250 or parts thereof on distributed computer systems, e.g. on virtual machines provided by computers of a data centre. The processes are described below, and the modules 250 are able to provide the components 120, 122, 124, 126, 128, 130, 132, 140 and 142 of the computer platforms 104, 106, 108.

The computer 202 includes random access memory (RAM) 206, at least one microprocessor 208, and external interfaces 210, 212, 214 that are all connected by a system bus 216. The external interfaces include universal serial bus (USB) interfaces 210, a network interface connector (NIC) 212, and a display adapter 214. The USB interfaces 210 are connected to input/output devices, such as a keyboard and mouse 218. The display adapter 214 is connected to a display device, such as an LCD display screen 222. The NIC 212 enables the computer 202 to connect to the communications network 150. The network 150 may include one or a combination of existing networks, such as a LAN, private WAN, the PSTN, the Internet, mobile cellular telephone networks, etc. The computer 202 includes an operating system (OS) 224, such as Microsoft Windows, Mac OSX or Linux. The modules 250 all run on the OS 224, and include program code written using languages such as C, Ruby or C#.

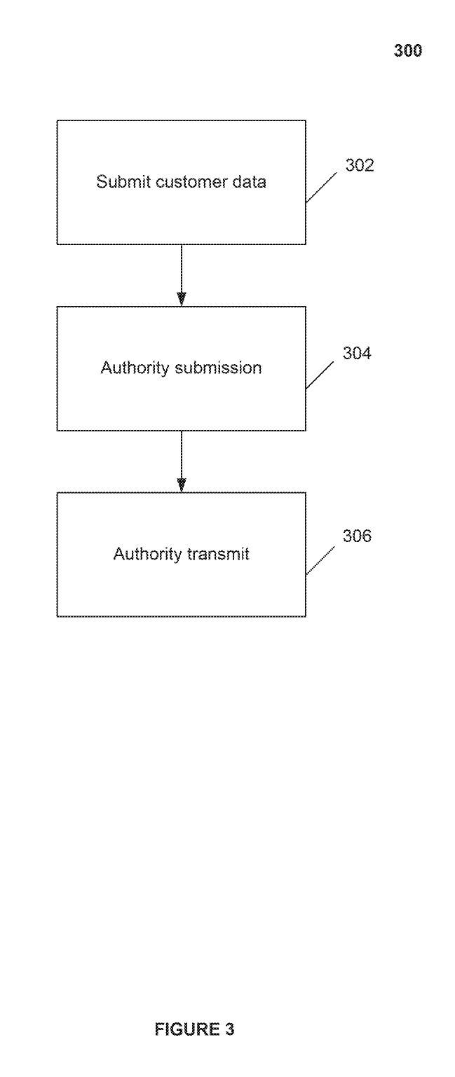

The electronic receipt platform 104 performs a registration process 300, as shown in FIG. 3. Using a client device 110, 112, 114 a customer is able to access a website published by the server 126 of the platform 104 that allows the customer to enroll for a e-receipt vault service provided by the platform 104. The customer first completes forms provided by the site to submit customer data (step 302) that includes identification and profile data unique to the customer. The customer data may include username, password, email address, mobile phone number or other contact details and profile data required by the receipt system 100. The customer data can also be submitted using a dedicated client application or app running on a client device 110, 112, 114. Once the customer data has been submitted, a unique, random and secure authentication token can be returned to the client device 110, 112, 114 for subsequent authentication of a connection session to the platform 104. The authentication token can be stored with the app.

Once the customer data has been submitted and the customer registered, the site of the platform 104 requires the customer to complete authority forms for any payment transaction accounts associated with the customer and for which the customer wishes the platform 104 to obtain transaction data therefrom. The payment account may be a credit or debit account, such those supported by Visa, American Express and MasterCard and provided by banks. The transaction data is aggregated for the customer and matched with receipt data of corresponding receipts, as described below. Depending on the requirements of the providers of the accounts, the customer may need to complete a variety of authority forms. Alternatively, the dedicated app may be associated with one account provider, and authority may implicit on registering the customer with the app or on invoking an authorisation control of the app. Once the customer has provided data using the site to complete an authority, it is submitted (step 304). Submitted authorities are then transmitted to the associated payment systems 108 (step 306). The authorities are required to allow or compel the payment transaction account provider to automatically send transaction data to the electronic receipt platform 104. An authority also provides the payment system 108 with customer identification data that is unique to the customer and will be used by both the receipt platform 104 and the payment system 108 to identify the customer. The customer identification data may include an account number, a username, a mobile phone number, or a randomly generated number that is unique to the customer.

In addition to authorising the collection of transaction data, an authority may also be given to release collected receipt data to a payment system 108 for verification or fraud purposes. Parts or the entirety of the registration process 300 may also be executed on sites provided by other parties, such as the merchant systems 106 or the payment systems 108. Authority may also be given to access online message data stores associated with the customer that may contain receipt data. For example, authority may be given to access the mail servers or web servers of a customer's Gmail, Yahoo or Outlook accounts in order to parse for receipts or invoices that may be attached and stored with messages of the customer's email account.

The receipt platform 104 needs to retain customer data that allows customers to access receipt data representing their respective electronic receipts, and the platform 104 needs to receive transaction data associated with at least one payment account associated with the customer.

The merchant systems 106 each include a receipt database system 132 to maintain at least one database 130 storing receipt data. The receipt data represents respective receipts issued to a customer of the merchant and for each receipt typically includes data representing the items purchased, the purchase price of each individual item, the date of the purchase, the total cost of the purchase (being the transaction amount), partial account numbers (e.g. credit or debit card digits), payment terminal identification (ID), and other data identifying the merchant or customer purchase. An item is a purchased product, such as a good or service. The receipt data may comprise all of the data generated by a point of sale (POS) terminal (e.g. electronic cash register) that is used to complete the payment transaction and issue a receipt, such as a paper receipt to the customer. The receipt data for each receipt may vary considerably and is generally unstructured. The receipt data is usually anonymous, meaning it is not associated with a customer identification or identifier (ID) and does not identify the purchasing customer.

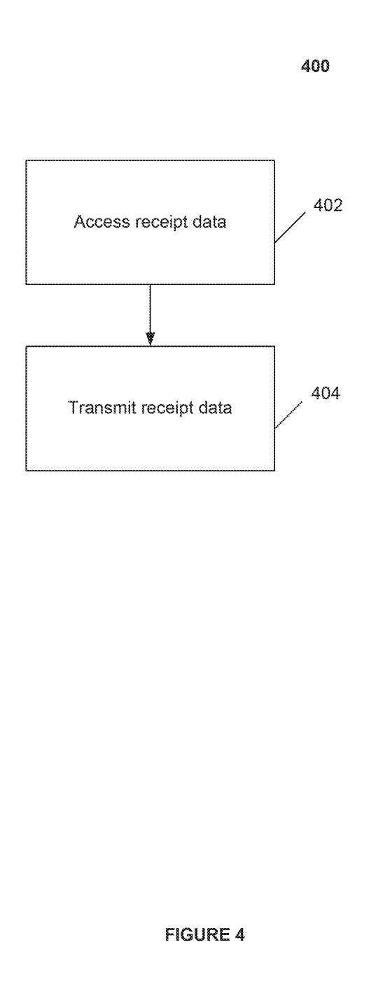

The merchant system 106 performs a receipt data acquisition process 400, as shown in FIG. 4, at regular intervals whereby new receipt data for the last period is accessed (step 402) and transmitted (step 404) to the receipt platform 104 for storage. The intervals or period may vary depending on the merchant system 106 and the update of the receipt data required. The access and transmission periods could be every n minutes, hours or days, n being a positive integer.

The web services system 128 of the receipt platform 104 is also able to perform a similar process to extract receipt data from authorised message data stores of a customer. The web services system 128 includes a scraping engine 160 to poll each message data store every m minute and examine the headers of messages to extract those that indicate that the messages have been sent by a merchant, e.g. using the merchant system 106, and which may include receipt data of a receipt. For example, messages sent from service@paypal.com are extracted. The scraping engine 160 parses the messages to identify and extract receipt data. The original message is then stored in the receipt platform 104 in association with its extracted receipt data in the vault database 120.

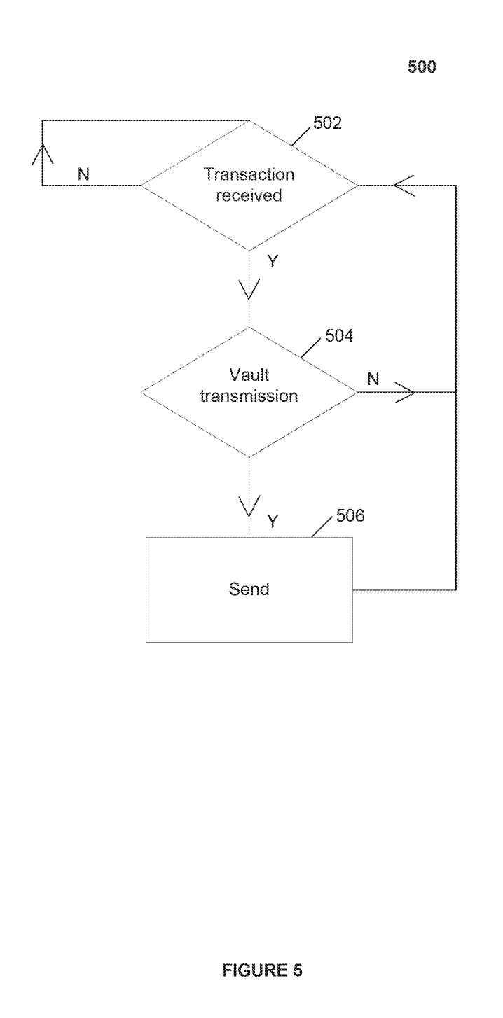

The payment system 108 executes a transaction submission process 500, as shown in FIG. 5. Whenever a payment transaction is recorded against a customer's payment account (step 502) at least one transaction database 140 is interrogated to check, e.g. against a flag, whether the customer has provided authority for the data associated with that transaction to be transmitted to the receipt platform 104 (step 504). If the authority has been provided and the flag set, a transaction database system 142 accesses the transaction data associated with the transaction and transmits it to the receipt platform 104 for storage (step 506). The transaction data is transmitted with the customer identification data used by both the receipt platform 104 and the payment platform 108. The transaction data may be transmitted when recorded. Alternatively, the database 140 may be regularly interrogated and transaction data for a number of transactions transmitted as a batch.

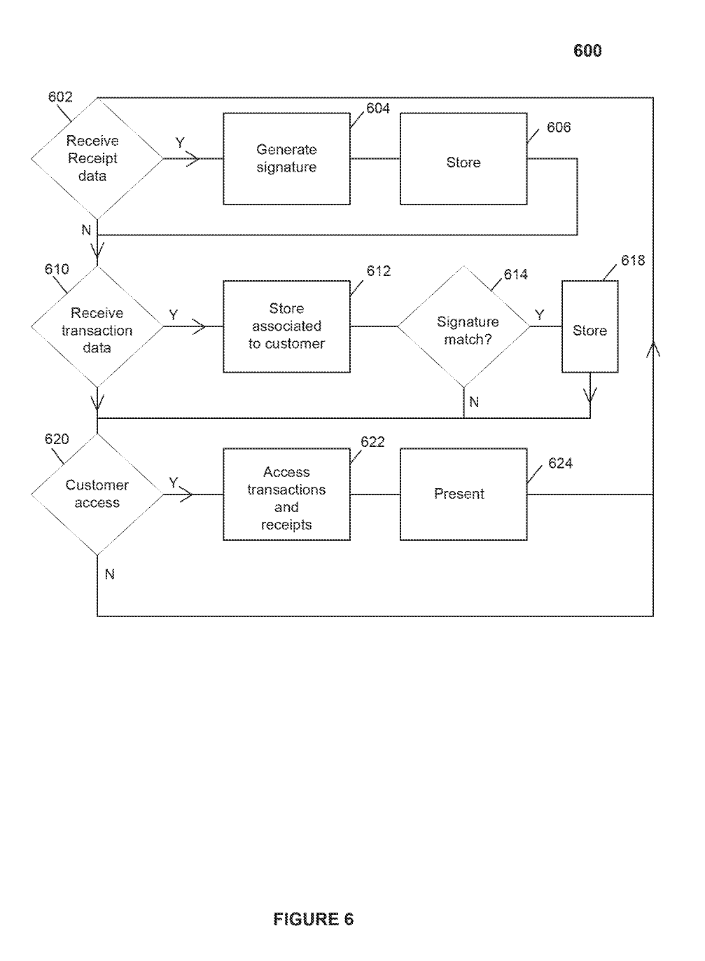

The electronic receipt platform 104 executes an electronic receipt reidentification, storage and presentation process, as shown in FIG. 6. The modules 250, and in particular the web services system 128 and the database system 122, operate to execute the process 600. The web services system 128 includes the scraping engine 160, at least one parser 162 to generate receipt signatures from the stored receipt data, and a matching engine 164 to execute a matching process 614.

The successful transmission of receipt data is identified and handled at step 602. The receipt data, as mentioned previously, can be received in a wide variety of formats and is generally anonymous, i.e. not associated with any particular customer. Some of the receipt data may, of course, include customer identifiers, particularly when receipt data is obtained from online retailers or merchants or a customer's message store. For traditional “bricks and mortar” merchants, the receipt data is likely to be that which has been generated by their payment (POS) terminals and will be unstructured and anonymous. Whilst the receipt data can be simply stored in the database 120 as it is received for subsequent processing, the platform 104 is able to process the receipt data to generate a unique receipt signature (step 604) for each receipt using the associated receipt data. The receipt signature can then be used in subsequent matching processes described below. The receipt signature is a unique combination of data elements of the merchant receipt that may be common to a payment account transaction record. For example, the receipt signature may include merchant identification data, date and type of payment transaction, the transaction amount (i.e. the dollar amount or total cost of the transaction), account or card digits, and payment terminal identification data. All the receipt data received for a purchase is stored for a receipt (step 606) with the unique receipt signature that is generated. The signature is generated by a parser that parses the received receipt data for the combination of data elements, e.g. the transaction date and amount. A different parser can be used for different merchants to generate the receipt signature, and the merchants can be identified by the merchant identification data of the receipt data. The merchant identification data could be a name value, number value and/or a messaging address, such as an email address.

Transaction data for a payment transaction is identified as being received at step 610. The transaction data includes customer identification data, merchant identification data, date and time of transaction, transaction amount, e.g. in dollars, and any other data recorded, such as transaction terminal identification data. The customer identification data received with each transaction record corresponds to customer identification data held by the receipt database 120, and initially supplied by the customer. The customer identification data may include an account number, a username or a mobile phone number, that is unique to the customer. The customer identification data allows the transaction data for each transaction to be stored in the vault database 120 in association with a respective customer (step 612). Once stored in association with a customer, the transaction data is processed to generate a transaction signature (step 614) that is then used by the database system 122 to seek to obtain a match with receipt data of a stored receipt, and in particular with a receipt signature of one of the stored receipts. The transaction signature includes similar or the same combination of data elements to the receipt signatures that are stored. For example, the data elements may include merchant identification, date or time of transaction, transaction amount, account or card digits, and terminal ID. The matching process 614 is able to execute approximate or fuzzy matching to account for data variations. For example, the date and time of transaction recorded with the receipt data may vary slightly to that recorded with the transaction data depending on clock errors in an EFTPOS terminal that acquires the transaction data and a merchant point of sale (POS) terminal that produces the receipt data. The receipt data processed by the matching process 614 can be confined to certain periods of time, i.e. time window limited, depending on the date and time of transaction. For receipt data obtained from invoices, the date and time of the receipt data and that of the transaction may vary by a number of days, and accordingly for particular transactions a longer time box or window may be needed to obtain a match between the receipt and transaction signatures. This allows account to be taken of the time lag between issuance of the receipt and the transaction that may occur for most transactions associated with specific merchants. The matching process 614 can also need to be augmented with heuristics and/or learning algorithms to obtain matches and the algorithms executed by the process 614 may require the input of the customer to assist in achieving a match. If receipt signatures are not generated, then the transaction signature is simply used to try and obtain a match with receipt data of any particular receipt.

If the process 614 locates a match with receipt data of a receipt, then that receipt data for that receipt is stored 618 as an electronic receipt in association with the transaction data for the transaction, and more importantly in association with the customer identification data for the customer. A unique URI is also generated in association with the matched receipt data to enable the original receipt data and/or message to be easily extracted from the vault database 120 by the customer using a web interface.

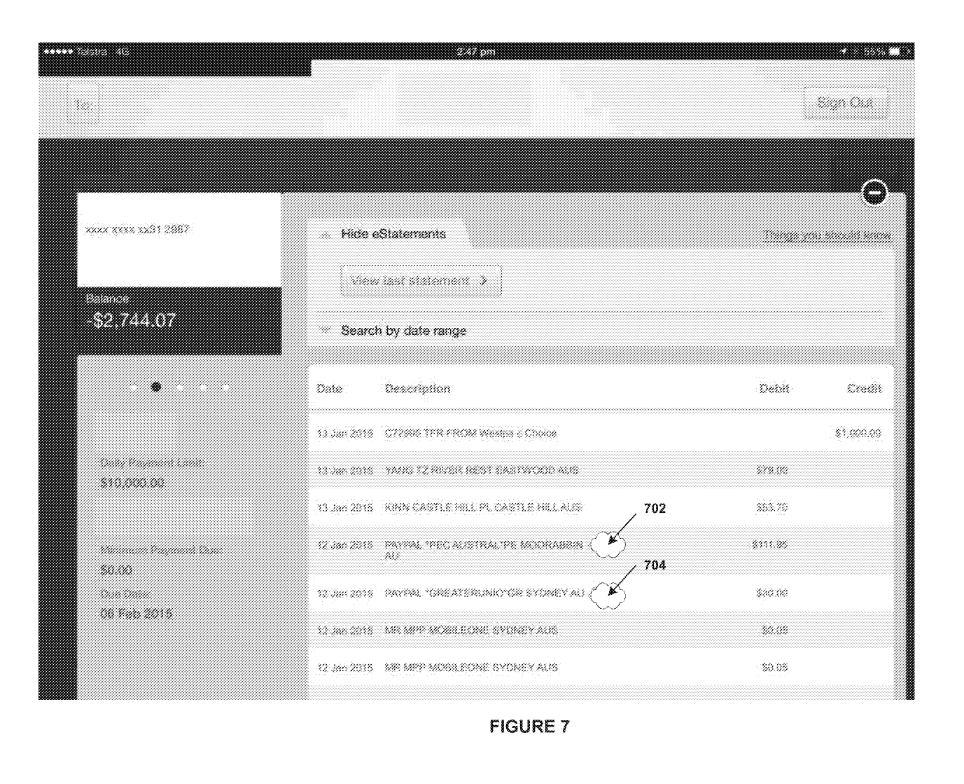

A customer is able to request access to all of the transaction data and electronic receipts stored in the vault 120, at step 620, on completion of an authentication process, which may involve submission of a unique username and password combination for the customer or return of the authorisation token. After authentication, access is allowed to the transactions and receipts which have been aggregated for the customer. Reports are dynamically generated and transmitted to present or provide the aggregated data and electronic receipts as required by the customer (step 624) on a customer's client device 110, 112, 114. The user interfaces generated by the platform 104 allow the customer to select particular transactions and then produce a display of all the retained receipt data of the electronic receipt associated with that transaction. The transaction data and electronic receipts stored in the vault can also be used by other systems 109 that are able to access the vault 120, such as expense management, personal financial management, accounting systems and data mining systems. An example of one the user interfaces is shown in FIG. 7 where the transactions of the payment account are listed. The transactions that have been matched with receipt data are indicated by the unique icon displays 702, 704 (e.g. a cloud icon) next to the displayed transaction. The icon 702, 704 is associated with the unique URI for the receipt data and it can be selected so as to return and present the full details of the electronic receipt associated with the selected transaction.

The electronic receipt system 100 has a number of advantages, and a significant advantage is that customers merely have to enroll in the e-receipt vault service, and grant authority to access transaction data from a payment transaction account, in order to have their receipts and purchase history stored for them in the vault database 120. Electronic receipts are automatically collected from merchant systems 106 or other systems 109 and associated with transaction records and the customer. The receipts are stored automatically for the customer. There is no need for the customer to collect, scan or submit receipts. The system 100 reidentifies anonymous receipts with respective customers, and also is able to provide the payment systems 108 with additional customer identification data they may not otherwise receive, such as email addresses and mobile phone numbers. Queries or charge back requests to providers of the payment systems 108 should also be considerably reduced now that receipts are matched or associated with transaction records.

Many modifications will be apparent to those skilled in the art without departing from the scope of the present invention.

1. A process performed by an electronic receipt computer system, including:
receiving and storing anonymous receipt data from a least one merchant system, the receipt data representing respective receipts for products purchased;
receiving transaction data, representing respective payment transactions and indicating the customer associated with each transaction;
processing the transaction data and receipt data to attempt to match the receipts to the transactions; and
storing the transaction data for a matched receipt in association with the receipt data for the matched receipt and customer identification data for the customer of the transaction.

2. A process as claimed in claim 1, wherein said processing includes generating a transaction signature from the transaction data for each transaction to match with said receipt data.

3. A process as claimed in claim 2, wherein said transaction signature includes at least one of merchant identification, date or time of transaction, transaction amount, account or card digits, and terminal ID data.

4. A process as claimed in claim 1, including generating a receipt signature from said receipt data for each receipt for matching with said transaction data.

5. A process as claimed in claim 4, wherein said receipt signature includes at least one of merchant identification, date and type of payment transaction, transaction amount, account or card digits, and payment terminal identification data.

6. A process as claimed in claim 1, wherein the customer identification data includes at least one of an account or card number, a username, a mobile phone number, and a generated number unique to the customer.

7. A process as claimed in claim 1, including accessing and presenting associated transaction data and receipt data for a client device when requested by the customer using the client device.

8. A process as claimed in claim 1, including accessing and transmitting associated transaction data and receipt data for processing by an expense management system, a personal financial management system, an accounting system, and a data mining system.

9. A process as claimed in claim 1, including receiving and submitting an authority from the customer to receive the transaction data, for at least one payment transaction account of the customer, from at least one payment system.

10. A process as claimed in claim 1, wherein the anonymous receipt data is received regularly and automatically from at least one merchant system.

11. An electronic receipt computer system, including a receipt database system and configured to perform a process as claimed in claim 1.

12. Computer storage including program code to cause an electronic receipt computer system, to perform a process as claimed in claim 1.

13. An electronic receipt system, including a receipt database system and configured to:
store receipt data representing respective receipts for products purchased;
receive, from at least one payment system, transaction data, representing respective payment transactions of a payment account of a customer;
process the transaction data and receipt data to attempt to match the receipts to the transactions;
store the transaction data for a matched receipt in association with the receipt data for the matched receipt and customer identification data for the customer of the transaction; and
access and provide associated transaction data and receipt data for a client device when requested by the customer using the client device.

14. An electronic receipt system as claimed in claim 13, wherein the receipt data is obtained by parsing a message store associated with the customer.

15. An electronic receipt system as claimed in claim 13, wherein the receipt data is obtained by from at least one merchant system.

16. An electronic receipt computer system, including:
at least one merchant system of a merchant storing receipt data representing respective receipts for products purchased from the merchant;
at least one payment system of a payment account provider storing transaction data representing respective payment transactions and indicating the customer associated with each transaction;
a receipt database system including:
a vault database storing the receipt data of receipts received from the at least one merchant system;
at least one parser generating respective receipt signatures from the receipt data for the receipts; and
a matching engine for matching the transaction data from the at least one payment system with the receipt signatures,
wherein the vault database stores the transaction data for a receipt matched by the matching engine in association with the receipt data for the matched receipt and customer identification data for the customer of the transaction.

17. An electronic receipt computer system as claimed in claim 16, wherein the receipt data is anonymous.

18. An electronic receipt computer system as claimed in claim 16, wherein the receipt database system accesses and provides associated transaction data and receipt data for a client device when requested by the customer using the client device.

19. A receipt reindentification process including:
processing anonymous receipt data of a receipt of a merchant system to generate a receipt signature; and
processing transaction data, representing respective payment transactions and indicating a customer associated with each transaction, to match transaction data of a payment transaction with the receipt signature and identify the customer with the receipt.

20. A receipt reidentification process as claimed in claim 19, including storing the matched transaction data in association with the receipt data and transmitting the matched transaction for display in association with the receipt data by a client device on request by the customer.
